(19) United States
(12) Patent Application Publication
(10) Pub. No.: US 2012/0042905 A1
(43) Pub. Date: Feb. 23, 2012

(54) EXTRACTION OF SURFACE CONTAMINANTS OF MAGNETIC TAPE

(75) Inventors: DYLAN J. BODAY, TUCSON, AZ (US); WAYNE A. McKINLEY, TUCSON, AZ (US); RICHARD A. WEST, TUCSON, AZ (US)

(73) Assignee: INTERNATIONAL BUSINESS MACHINES CORPORATION, ARMONK, NY (US)

(21) Appl. No.: 12/861,673

(22) Filed: Aug. 23, 2010

(51) Int. Cl. B08B 3/00

(52) U.S. Cl. 134/9; 134/122 R

(57) ABSTRACT

Methods for preparing for analysis of surface contamination of magnetic tape, in one embodiment, submerses and passes a continuing length of the magnetic tape through a covered water bath; and subsequent to the submersing step, wipes the continuing length of the magnetic tape while covered. The preparation is conducted, in one embodiment, with a covered enclosure configured to enclose a water bath to a level at least submersing guide(s) and a continuing length of the magnetic tape passed by the guide(s). A wiping arrangement is configured to wipe the continuing length of magnetic tape subsequent to the submersion in the water bath. Further, the covered enclosure comprises openings therein to pass the continuing length of magnetic tape.

### CROSS REFERENCE TO RELATED APPLICATION

Commonly assigned copending U.S. Patent Application Ser. No. (TUC920100107US1), filed on even date herewith, relates to the cleaning of the surfaces of magnetic tape.

### FIELD OF THE INVENTION

This invention relates to magnetic tape, and more particularly, to preparation for the analysis of contaminants of the magnetic tape.

### BACKGROUND OF THE INVENTION

Magnetic tape comprises an important media for the storage of data, including the long term storage and archiving of data. The presence of ionic materials on the surface of magnetic tape is becoming increasingly important due to the potential corrosion caused by ionic species. Some examples comprise chlorine, fluorine, iodine and bromine salts, and phosphates and sulfates. These corrosion species commonly come from environmental sources and deposit onto the tape surface that can then cause corrosion to the tape, and to surfaces and components of a tape drive that the tape is used in.

A magnetic tape is long, for example, 600 meters, so that analysis of a portion of a tape may not provide information regarding the remainder of the tape.

### SUMMARY OF THE INVENTION

Methods and apparatus are provided for extraction of surface contaminants of magnetic tape.

In one embodiment, the method comprises submersing and passing a continuing length of the magnetic tape through a covered water bath; and subsequent to the submersing step, wiping the continuing length of the magnetic tape while covered.

In a further embodiment, the continuing length of the magnetic tape, measured as the length of magnetic tape submerged in the covered water bath, is less than 1/1000 of total length of the magnetic tape.

In another embodiment, the submersing and passing step comprises a speed of longitudinal passing of the magnetic tape of between 0.01 meters per second and 0.3 meters per second.

In a further embodiment, the speed comprises substantially 0.2 meters per second.

In another embodiment, the wiping step comprises wiping both sides (front and back) of the magnetic tape.

In a further embodiment, the wiping step comprises wiping both sides of the magnetic tape simultaneously in a squeegee action.

In a still further embodiment, the wiping step comprises passing the continuing length of magnetic tape between opposed brushes, the brushes contacting respectively the front and the back of the magnetic tape.

In a further embodiment, the brushes comprise polymer brushes.

In another embodiment, the water bath is heated to a temperature of between room temperature and 70 degrees Celsius.

In still another embodiment, subsequent to the wiping step, the continuing length of magnetic tape is dried externally of the covered water bath.

In another embodiment, a system for extracting surface contaminants of magnetic tape, comprises at least one guide configured to pass a continuing length of magnetic tape thereby; a covered enclosure configured to enclose the at least one guide and a water bath to a level at least submersing the guide(s), and submersing a continuing length of the magnetic tape passed by the guide(s); and a wiping arrangement configured to wipe the continuing length of magnetic tape subsequent to the submersion in the water bath.

In a further embodiment, the covered enclosure comprises openings therein to pass the continuing length of magnetic tape.

For a fuller understanding of the present invention, reference should be made to the following detailed description taken in conjunction with the accompanying drawings.

### BRIEF DESCRIPTION OF THE DRAWINGS

FIG. 1 is a diagrammatic illustration of a system configured to extract surface contaminants from a magnetic tape;

FIGS. 2A and 2B are illustrations of respectively, a container and cover of the system of FIG. 1;

FIG. 3 is a flow chart depicting an exemplary method of operating the system of FIGS. 1 and 2;

FIGS. 4A and 4B are illustrations of an embodiment of the guide and support apparatus of the system of FIGS. 1 and 2; and

FIGS. 5A and 5B are illustrations of an alternative embodiment of the guide and support apparatus of the system of FIGS. 1 and 2.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

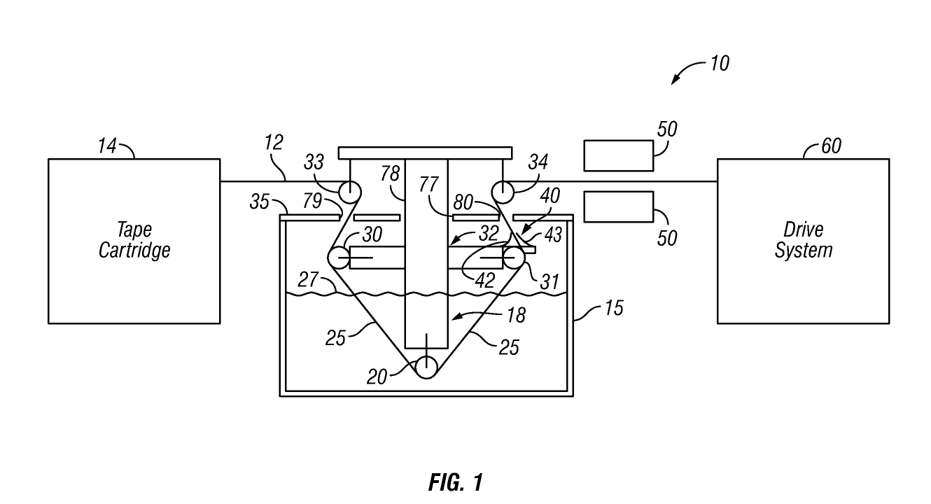

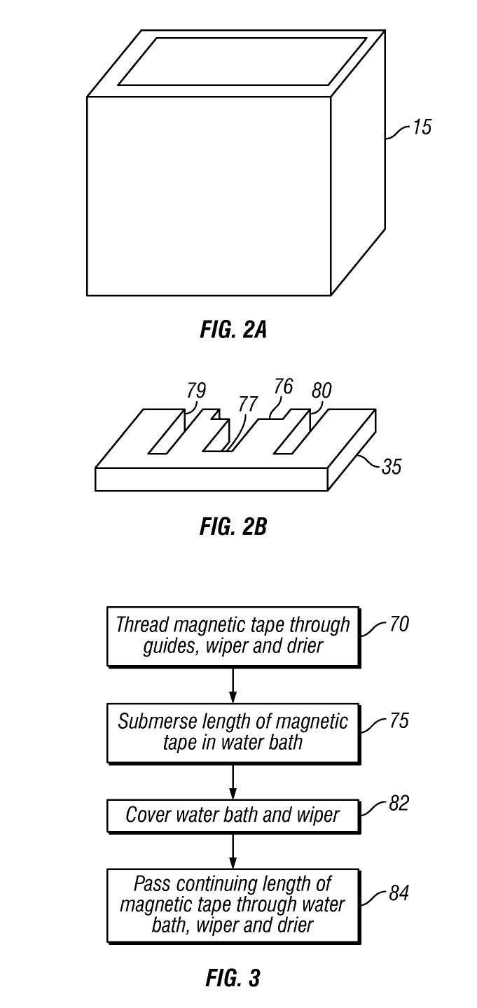

Referring to FIGS. 1, 2A and 2B, an example of a system 10 is illustrated which is configured to extract and concentrate surface contaminants from a magnetic tape 12 of a tape cartridge 14. The surface contaminants of interest comprise ionic materials that are becoming increasingly important due to the potential corrosion caused by these ionic species. The corrosion species commonly come from environmental sources and deposit onto the tape surface and then can cause corrosion to surfaces and components of magnetic tape drives employed to write and read data with respect to the magnetic tape. The system 10 is configured to provide a non-destructive extraction of the surface contaminants from substantially an entire spool of magnetic tape of tape cartridge 14 using a small volume of water and to concentrate the extracted materials for detection and analysis of the ionic materials.

The extraction system 10 comprises a container 15 and a guide system 18 of at least one guide 20 configured to pass a continuing length 25 of magnetic tape 12. The guide system 18 is configured to guide and pass the continuing length of tape 25 within a water bath 27, submersing the magnetic tape in the water bath.

The magnetic tape may be supported and directed by additional guides such as guides 30 and 31, supported by support 32, which are configured to guide the magnetic tape 25 within the container 15, and by guides 33 and 34 outside the container 15. The guides may comprise bearings with or without flanges, or may comprise cylindrical surfaces with or without flanges, to guide the magnetic tape along the tape path, as will be discussed.

A cover 35 is placed so as to cover the water bath 27 and the guides 30 and 31 that are within the container 15. The cover 35 minimizes the water loss from water bath 27 due, for example, to splashing and evaporation.

Submersion of the continuing length of magnetic tape 25 in the water bath 27 dissolves the ionic materials, thereby extracting the materials from the magnetic tape into the water bath.

A wiping arrangement 40, or wiper, for example comprising opposed brushes 42 and 43, is configured to contact respectively the front and back of the magnetic tape as the continuing length of magnetic tape exits the water bath. The magnetic tape passes between the opposed brushes 42, 43 subsequent to submersion in the water bath 47, while the magnetic tape is within the covered enclosure 15, 35. The wiping arrangement 40, or wiper, thereby wipes both sides of the magnetic tape to reduce the likelihood that water is carried from the bath 27 on the tape. In one example, the brushes of wiper 40 wipe both sides of the magnetic tape simultaneously in a squeegee action.

The magnetic tape is directed through a notch in the cover 35 and guide 34 directs the magnetic tape 12 through a drier 50. The drier 50 is external to the water bath enclosure and may, for example, be an air drier configured to dry both sides of the magnetic tape 12. The temperature of the air drier does not exceed 70 degrees Celsius, and the drying is primarily from the movement of the air blowing onto the tape surface. Air driers are known to those of skill in the art. Drier 50 is intended to further dry the magnetic tape and to eliminate the possibility that the tape surfaces would become stuck once the magnetic tape is rewound in the tape cartridge 14.

A drive system 60 pulls the magnetic tape in a longitudinal path extending from the tape cartridge 14, through the water bath 27, submerging the continuing length of magnetic tape 25 in the water bath, through wiping arrangement 40, and through external drier 50. The drive system 60 is arranged to move the tape longitudinally from the tape cartridge 14 with a tension sufficient to maintain the magnetic tape 12 against the guides 33, 30, 20, 31 and 34 without the development of slack. The entire spool of magnetic tape from tape cartridge 14 is thus submerged in water bath 27 to extract the ionic materials into the water bath and the wiping arrangement 40, for example comprising opposed brushes 42 and 43, ensures that the extracted ionic materials remain in the water bath, concentrating the ionic materials in the small amount of water comprising the water bath. The concentration allows a subsequent analysis of the ionic materials.

Once substantially the entire length of magnetic tape has passed through the water bath 27, the magnetic tape is withdrawn from enclosure 15 and is rewound into the tape cartridge 14, for example, by the drive system 60.

Referring additionally to FIG. 3, the method for extracting the ionic materials comprises, in step 70, threading the magnetic tape 12 into the guide system 18, and through the wiping arrangement 40 and drier 50. In the illustrated example, the magnetic tape is also threaded along guides 33, 30 and along guide 20 of guide system, and threaded along guide 31 and through the brushes 42, 43 of wiping arrangement, or wiper, 40, and along guide 34 and through the drier 50 to drive system 60.

Water is placed in the container 15 to form the water bath 27, and, in one example, in step 75, the unit comprising guide system 18 and support 32 and guides 30 and 31 are placed within the container 15 while the cover 35 is off and placed at the proper depth in the water bath 27 so as to submerse guide 20 and length of magnetic tape 25 in the water bath. Brushes 42 and 43 are not submersed. Referring to FIGS. 1 and 2B, the support 32 and guide system 18 are supported by a back bracket which may be attached to the rear of the container 15, for example above the water bath. The notch 76 is arranged to clear the back bracket, while notch 77 is arranged to clear the vertical portion 78 of the support 32. Further notches 79 and 80 are arranged to clear the magnetic tape as it enters and exits the container 15, respectively.

The water bath 27 may be heated to a temperature of between room temperature and 70 degrees Celsius, either preheated before being placed in container 15, or container 15 may comprise a heating element to heat the water bath.

Referring to FIGS. 1, 2A, 2B and 3, in step 82, cover 35 is placed at the container 15 so as to cover at least the water bath 27. In the example, the cover is placed on the top of the container 15, covering the water bath 27, length of magnetic tape 25 and wiper 40.

In step 84, the continuing length of magnetic tape 25 is drawn by drive system 60 along the guides to pass the continuing length of magnetic tape through the water bath 27, submerging the continuing length of magnetic tape in the water bath, then from the water bath through wiper 40 and from the container 15 through the external drier 50.

The drive system 60 passes the magnetic tape in the longitudinal direction of the tape at a speed of between 0.01 meters per second and 0.3 meters per second. In a specific embodiment, the speed comprises substantially 0.2 meters per second.

Thus, the continuing length of magnetic tape is submersed and passed through a covered water bath; and, subsequent to the submersing step, the magnetic tape is wiped while the magnetic tape is covered.

The entire spool of magnetic tape 12 from tape cartridge 14 is thus drawn through the water bath, the water bath extracting the ionic materials that are present on the surface of the magnetic tape into the water bath. A magnetic tape 12 is long, for example, 600 meters, so that passing a continuing length of the magnetic tape 25, which comprises less than 1/1000 of total length of the magnetic tape 12, through the water bath 27 results in extracting and concentrating the ionic materials in the water bath. The small size of the water bath 27 through which the tape is passed concentrates the ionic materials for analysis to determine the ionic species that contaminated the magnetic tape 12. As discussed above, some examples comprise chlorine, fluorine, iodine and bromine salts, and phosphates and sulfates. These corrosion species commonly come from environmental sources and deposit onto the tape surface that can then cause corrosion to the tape, and to surfaces and components of a tape drive that the tape is used in.

Once the magnetic tape 12 has been passed through the water bath, it may be removed from container 15 and rewound back into tape cartridge 14.

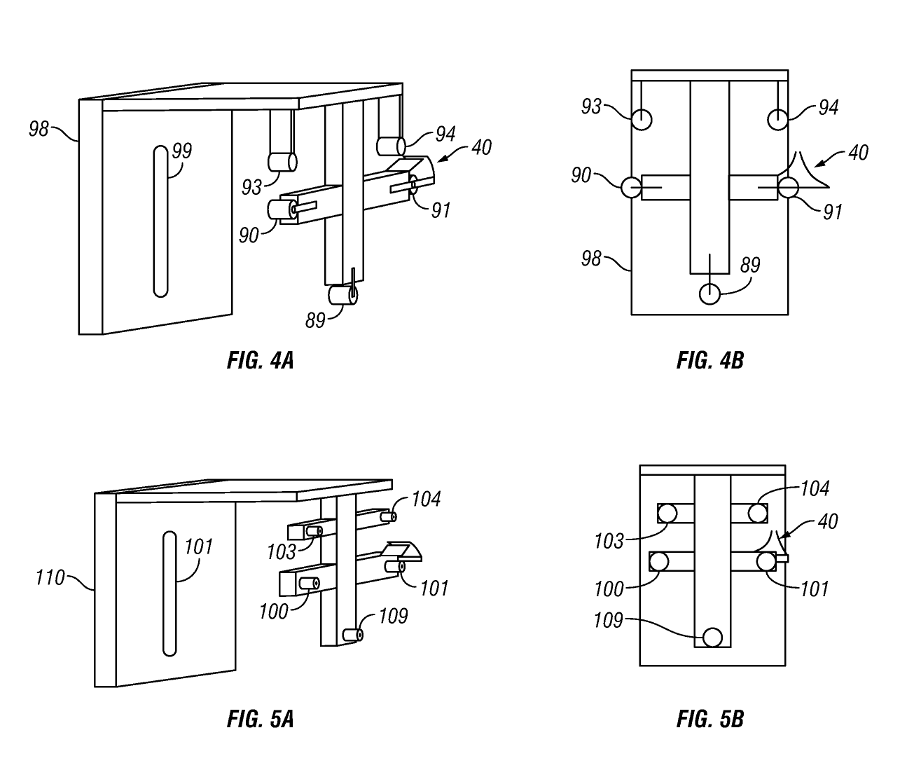

FIGS. 4A and 4B illustrate one embodiment of the guide system, support, guides and bracket that may be employed in the system 10 of FIG. 1. Guides 93, 90, 89, 91 and 94 correspond to guides 33, 30, 20, 31 and 34 respectively of FIG. 1. The guides 93, 90, 89, 91 and 94 comprise roller bearing guides which may comprise flanges to guide the magnetic tape. Examples of such roller bearing guides are known to those of skill in the art. The wiper 40 is also illustrated. The wiper and guides are supported by a bracket 98 that may be attached through slot 99 to the rear of the container 15 of FIG. 1.

FIGS. 5A and 5B illustrate an alternative embodiment of the guide system, support, guides and bracket that may be employed in the system 10 of FIG. 1. Guides 103, 100, 109, 101 and 104 correspond to guides 33, 30, 20, 31 and 34 respectively of FIG. 1. The guides 103, 100, 109, 101 and 104 comprise cylindrical surfaces, such as pins which may comprise flanges to guide the magnetic tape. Examples of such cylindrical surfaces, partial or full, are known to those of skill in the art. The wiper 40 is also illustrated. The wiper and guides are supported by a bracket 110 that may be attached through slot 111 to the rear of the container 15 of FIG. 1.

Referring to FIG. 1, drive system 60 may comprise any suitable means for winding the magnetic tape 12 on a take up reel, passing the magnetic tape through the water bath 27 and through the wiper 40 and drier 50 with a small amount of tension on the magnetic tape 12 to maintain the magnetic tape in the tape path. One example comprises a drive motor and take up reel of a magnetic tape drive.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A method of extraction of surface contaminants of magnetic tape, comprising the steps of:
submersing and passing a continuing length of said magnetic tape through a covered water bath; and
subsequent to said submersing step, wiping said magnetic tape while said magnetic tape is covered.

2. The method of claim 1, wherein said continuing length of said magnetic tape, measured as the length of magnetic tape submerged in said covered water bath, is less than 1/1000 of total length of said magnetic tape.

3. The method of claim 1, wherein said submersing and passing step comprises moving said magnetic tape at a longitudinal passing speed of between 0.01 meters per second and 0.3 meters per second.

4. The method of claim 3, wherein said speed comprises substantially 0.2 meters per second.

5. The method of claim 1, wherein said wiping step comprises wiping both sides (front and back) of said magnetic tape.

6. The method of claim 5, wherein said wiping step comprising wiping said both sides of said magnetic tape simultaneously in a squeegee action.

7. The method of claim 6, wherein said wiping step comprises passing said continuing length of magnetic tape between opposed brushes, said brushes contacting respectively said front and said back of said magnetic tape.

8. The method of claim 7, wherein said brushes comprise polymer brushes.

9. The method of claim 1, wherein said water bath is heated to a temperature of between room temperature and 70 degrees Celsius.

10. The method of claim 1, additionally comprising, subsequent to said wiping step, drying said continuing length of magnetic tape externally of said covered water bath.

11. System for extraction of surface contaminants of magnetic tape, comprising:
at least one guide configured to pass a continuing length of magnetic tape thereby;
a covered enclosure configured to enclose said at least one guide and a water bath to a level at least submersing said at least one guide, and submersing a continuing length of said magnetic tape passed by said at least one guide; and
a wiping arrangement configured to wipe said magnetic tape subsequent to said submersion in said water bath, while said magnetic tape is within said covered enclosure.

12. The system of claim 11, wherein said covered enclosure comprises openings therein to pass said continuing length of magnetic tape.

13. The system of claim 12, wherein said continuing length of magnetic tape, measured as the length of magnetic tape submerged in said covered water bath, is less than 1/1000 of total length of said magnetic tape.

14. The system of claim 11, wherein said wiping arrangement is arranged to wipe both sides (front and back) of said magnetic tape.

15. The system of claim 14, wherein said wiping arrangement is arranged to wipe said both sides of said magnetic tape simultaneously in a squeegee action.

16. The system of claim 15, wherein said wiping arrangement comprises opposed brushes configured to contact respectively said front and said back of said magnetic tape as said continuing length of magnetic tape passes between said opposed brushes.

17. The system of claim 16, wherein said brushes comprise polymer brushes.

18. The system of claim 11, additionally comprising a heat generator configured to heat said water bath to a temperature of between room temperature and 70 degrees Celsius.

19. The system of claim 11, additionally comprising a drier external of said covered water bath configured to be in a path of said continuing length of magnetic tape subsequent to said wiping arrangement, configured to dry said continuing length of magnetic tape.

20. The system of claim 11, additionally comprising a drive system for moving said magnetic tape in the longitudinal direction such that said continuing length of magnetic tape passes said at least one guide at a speed of between 0.01 meters per second and 0.3 meters per second
